(19) United States
(12) Patent Application Publication
(10) Pub. No.: US 2002/0091987 A1
(43) Pub. Date: Jul. 11, 2002

(54) Information retrieval system for design generation

(76) Inventor: Rifat Kamil Chadirji, Kingston-upon-Thames (GB)

Correspondence Address: Michael B. McMurry, 1210 Astor Street, Chicago, IL, 60610, US

(21) Appl. No.: 09/793,277

(22) Filed: Feb. 26, 2001

(30) Foreign Application Priority Data
Jan. 11, 2001 (GB) 0100710.3

(51) Int. Cl. G06F 7/00

(52) U.S. Cl. 717/100

(57) ABSTRACT

An information retrieval system for the generation of building design documentation includes a database and a matrix enabling acquisition of selected data from the database to select and define customised design configurations in accordance with requirements.

### BACKGROUND OF THE INVENTION

### FIELD OF THE INVENTION

This invention relates to an information retrieval system for design generation.

The invention has reference to such a system for retrieving, in a structured manner and on a preselectable basis, individual element design data from a database containing information regarding a plurality of elements thereby enabling the generation of an overall customised design specification.

The invention has especial applicability in the field of building and architecture where, conventionally, the design of architectural elements and their composite components associated with a building are generated on an individual basis with the architect or draughtsman laboriously preparing drawings for each element and/or component with discrete dimensions applying.

As will be readily recognised, the preparation of architectural drawings and other documentation of the elements occasions a high cost commensurate with the time taken on these tasks.

It would be of obvious and not inconsiderable advantage if the need for the design-specific aspect of individual elements were to be obviated thus facilitating the generation of a customised overall design on the basis of readily available design data drawn from a preloaded database platform.

### SUMMARY OF THE INVENTION

An object of the invention is therefore to provide an information retrieval system for design generation, which will facilitate the overall design functions and obviate the need for repetitive individual design activity.

A further object of the present invention is to provide a method of using such a system.

Accordingly one aspect of the invention provides an information retrieval system for building production documentation including a database containing a bank of data relating to a multiplicity of design elements and components and types and parameters relating thereto and at least one design selection matrix having at least two co-ordinates one of which is adapted to permit definition of the relevant element and the other of which is adapted to permit selection of a desired component and the type and appurtenant parameter thereof, thereby to generate a customised design of the element and provide a comprehensive overall design strategy for the building production documentation.

The term ‘elements’ as used herein relates to the primary parts of the building, such as the foundation, floors, roof and doors and the like and the term ‘components’ refers to sub-elements or specific features of the elements.

The design selection matrix possesses two co-ordinates, a horizontal and a vertical co-ordinate, wherein the vertical co-ordinate is adapted to define the specific element of the building, in this co-ordinate called ‘a set’, e.g. foundation, floors, curtains, windows or door opening, whereas the horizontal co-ordinate is adapted to allow the prescription of specific components as desired to be applied to the relevant the design of the element, these aspects of the components being found in what in this co-ordinate are called ‘bays’. Such component options may be of a dimensional character, and/or relate to the particular optional design features and their type and any other parametric property thereof. The components may for example relate to features of a specific curtain or a wall or a floor.

The architect or builder will in practice define a set in the vertical co-ordinate by dint of its type and intended disposition in the building, and will then be able to prescribe for each set the particular characteristics required as selected from the bays in reference to the database. In each bay there will be provided a number of optional components and the operator, i.e. the architect or builder, will select which component option should be applied to the set, and will proceed to make selections for all the aspects of the relevant component. The degree to which the component and its parameters are required to be defined will dictate the complexity of the detail available in the individual bay and dependent upon the refinement of such detail, the individual bay may contain sub-divisions allowing a more comprehensive prescription. Representations of the components may also be provided within the database for visual recognition and selection assistance to the operator. Each bay will be numbered whereby the relevant component can easily be defined and cross-referenced with the representations to facilitate identification.

Each of the sets may be coded in order to simplify their definition and such coding may be in accordance with national standards within the architectural and building professions. Built into the database will be representations of the relevant components, which will also include dimensional information prescribing the size and shape of the various components, thereby allowing an interrelationship with the data available for optional selection within the bays.

According to a second aspect of the present invention there is provided a method of using the system of the first aspect to generate building production documentation including the steps of selecting from the database a number of sets related to the desired element of the building to be designed, selecting for each set a number of optional components and thereby defining the design parameters relating thereto, and generating a customised and comprehensive overall design strategy for the building production documentation.

According to a third aspect of the invention there is provided a computer program enabling the generation of the database and for accessing the data for the purposes of the first and second aspects of the invention.

The invention also includes the database and its creation by capturing and inputting data from a wide spectrum of available information current within the architectural and building industries as a precursor to the exercise of the first three aspects of the present invention.

### BRIEF DESCRIPTION OF THE DRAWINGS

By way of example, an information retrieval system for building production documentation according to the invention is described in its various aspects with reference to the accompanying diagrams in which:

FIG. 1 shows a matrix for use in the present invention with appropriate designations; and

FIG. 2 shows a matrix similar to that shown in FIG. 1 but providing the facility for sub-classification and provided with appropriate designations.

### DETAILED DESCRIPTION OF THE PREFERRED EMBODIMENTS

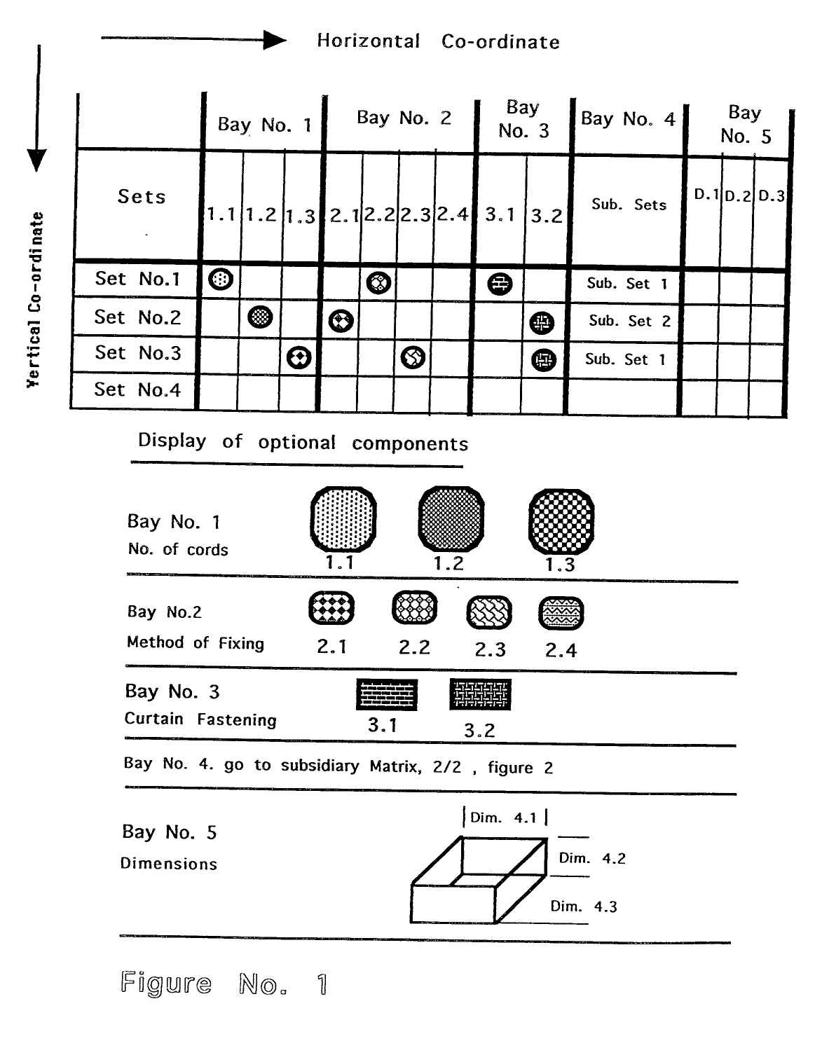

Referring first to FIG. 1 there is shown a matrix with horizontal and vertical co-ordinates to be described below, and beneath the matrix is shown a variety of visual symbolic representations of optional components shown in diagrammatic form.

The vertical co-ordinate predefines the ‘sets’ which effectively replace drawings and which relate to specific elements of a building, for example wall, floors, windows, piles, signs, bathroom fixtures, electrical installations, shelves etc. A particular feature, in this example a curtain for a window, is assigned to a set, let it be Set No 1.

The horizontal co-ordinate predefines the ‘bays’ to each of which effectively is assigned an optional component related to the set, for example the component may apply to the number of cords the curtain should possess, the method of fixing, the curtain fastening and the dimensions of the curtain. As will be seen from FIG. 1 the bays are numbered and additionally sub-classified to give a specific reference to the particular optional details of the relevant component.

In this example, the following selection options are displayed on a VDU monitor for each of the relevant bays 1 to 9:

Bay No 1. Two Sections for the number of curtains required in the set: 1.1 a single curtain; 1.2 two curtains etc.

Bay No 2. Four Sections relating to alternative design options for channels and cords for the curtains: 2.1 Single Channel; 2.2 Two Channel; 2.3 Single Cord; 2.3 Double Cord etc.

Bay No 3. Five Sections relating to alternative design options for the method of fixing: 3.1 Wall Mounting; 3.2 Pelmet Mounting; 3.3 Ceiling Mounting; 3.4 Wall Bracket etc.

Bay No 4. Two Sections relating to alternative design options for the type of fixing: 4.1 Surface Mounting; Recessed Mounting.

Bay No 5. Three Sections relating to various Draw Sets for the curtains: 5.1 One Draw Set; 5.2 Two Draw Set; 5.3 Multiple Draw Set.

Bay No 6. Two Sections relating to alternative design options for the Glider and Runners: 6.1 Nylon Glider; 6.2 Double Roller Runner; 6.3 Ball Bearing Runner.

Bay No 7. Four Sections relating to alternative design options for the Curtain Fastening: 7.1 Clip; 7.2 Hook; 7.3 Sew-on; 7.4 Fastening Tape;

Bay No 8. Five Sections relating to alternative design options for other accessories: 8.1 End Stop; 8.2 Overlay Attachment; 8.3 Baton; 8.4 Cord Weight; 8.5 Cord Tension Pulley.

Bay No 9. Two Sections relating to alternative design options for the shape of the pelmet as depicted in drawings (not shown) available on the database.

In practice, the architect or builder or for that matter the Client would for each set select the appropriate option and the combination of selections as chosen would constitute the definitive design for the set, the design being coded for ease of use. Once the selection has been made, then a complete configurative formula for the set is available without the need to generate drawings which are time consuming and expensive. The application of the formula is simple with all the components and their manner of application predetermined by the selection process.

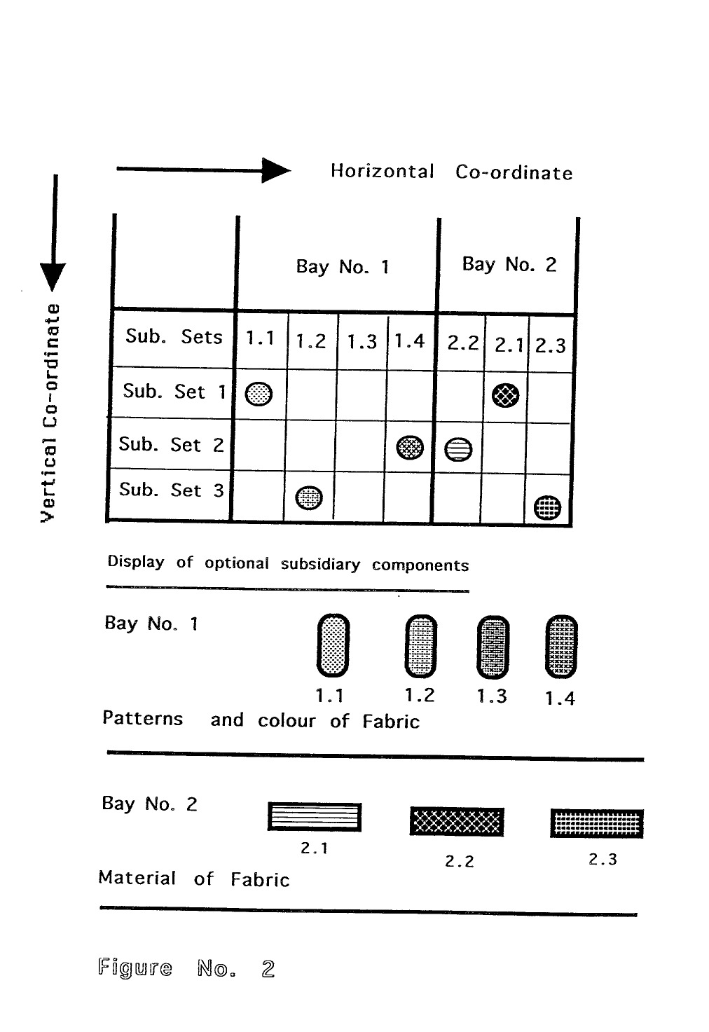

With reference to FIG. 2 an additional matrix is shown for bay 4 (the numeral in this case having been chosen at random, or other bays where the sub-classification would have appropriate relevance could be chosen), giving further refined options in terms of subsidiary details for example the patterns, colour and nature of the curtain fabric. Accordingly sub-sets are provided and appear as such in the matrix as shown, the choice being illustrated or otherwise defined.

It is to be understood that the present invention is put into practice with the aid of a computer program including the database from which the selection of the available options is made, the program displaying on screen in appropriate form including graphics where appropriate the selected formula for each set. In essence, the formulae become instructions to the builder or fitter to complete the relevant works thus obviating the need for detailed drawings. The codes provided by the formulae are interpreted according to predefined data banks and the correct components for the relevant set are then made available for installation.

I claim

1. An information retrieval system for building production documentation including a database containing a bank of data relating to a multiplicity of design elements and components and types and parameters relating thereto, and at least one design selection matrix having at least two co-ordinates one of which is adapted to permit definition of the relevant element and the other of which is adapted to permit selection of a desired components and the type and appurtenant parameter thereof, thereby to generate a customised design of the element and provide a comprehensive overall design strategy for the building production documentation.

2. An information retrieval system for building production documentation including a database containing a bank of data relating to a multiplicity of design elements and components and types and parameters relating thereto, and at least one design selection matrix having a horizontal and a vertical co-ordinate, wherein the vertical co-ordinate is adapted to define the specific element of the building and the horizontal co-ordinate is adapted to allow the prescription of specific optional components and specific aspects thereof as desired to be applied to the relevant element.

3. A system according to claim 2 in which at least one set is defined along the vertical co-ordinate and at least one bay is defined along the horizontal co-ordinate.

4. A system according to claim 3 in which the said specific aspects are of a dimensional character.

5. A system according to claim 3 in which the specific aspects relate to the particular components and their type and any other parametric property thereof.

6. A system according to claim 5 in which an option is provided in respect of each defined aspect.

7. A system according to claim 5 in which representations of the components are provided within the database for visual recognition and selection assistance.

8. A system according to claim 7 in which each bay is numbered whereby the relevant component is defined and cross-referenced with the representations to facilitate identification.

9. A system according to claim 3 in which each of the sets is coded.

10. A system according to claim 3 in which representations of the relevant sets are built into the database which includes dimensional information prescribing the size and shape of the building components, thereby allowing an interrelationship with the data available for selection within the bays.

11. A method of using the system according to claim 3 to generate building production documentation, the method including the steps of selecting from the database a number of sets related to the desired elements of the building to be designed, selecting for each set at least one component and defining the design parameters relating thereto, and generating a customised and comprehensive overall design strategy for the building production documentation.
